(19) United States
(12) Patent Application Publication
(10) Pub. No.: US 2012/0186933 A1
(43) Pub. Date: Jul. 26, 2012

(54) CLUTCH AND A METHOD OF MODIFYING A CLUTCH

(75) Inventors: Don WISHARD, Newell, SD (US); Brad CARLSON, Whitewood, SD (US); Stuart WILLIAMS, Spearfish, SD (US); Gary HAMILTON, Rapid City, SD (US)

(73) Assignee: LEHMAN TRIKES U.S.A., INC., Spearfish, SD (US)

(21) Appl. No.: 13/013,165

(22) Filed: Jan. 25, 2011

(51) Int. Cl. F16D 25/12; F16D 19/00; B23P 11/00; F16D 21/00

(52) U.S. Cl. 192/85.63; 192/82 R; 192/89.2; 29/401.1

(57) ABSTRACT

A manually-operated clutch has an actuator and a force limiter. The actuator has a control portion and an engagement portion, the control portion controlling a motive force that engages the engagement portion with a transmission. The force limiter is between the control portion and the engagement portion and limits the motive force above a predetermined threshold.

### FIELD

There is described a clutch and a method of modifying an existing clutch.

### BACKGROUND

Aggressive or abusive operation of a motorized vehicle can lead to premature failures in transmissions or clutches. When a clutch is “popped” at high engine rpm, components experience a sudden high load as the clutch engages. This can result in a high rate of clutch wear or early failure of driveline components.

### SUMMARY

In a manually operated clutch, there is provided an actuator with a force limiter. The actuator has a control portion and an engagement portion. The control portion controls a motive force that engages the engagement portion with a transmission. The force limiter is between the control portion and the engagement portion and the motive force above a predetermined threshold. The control limiter prevents excessive pressure from being transferred through the actuator to cause damage to either the clutch or the transmission, When a motorized vehicle clutch is operated in a normal manner, the force limiter is not required. However, when a motorized vehicle clutch is operated in an aggressive or abusive manner, the force limiter acts to reduce the force along the actuator.

There is also provided a method of converting an existing clutch to incorporate the actuator with the force limiter, wherein the force limiter is installed between the control portion and the engagement portion.

Different types of actuators may be used. For example, the actuator may be a hydraulic actuator, and the motive force may be hydraulic fluid under pressure. For a hydraulic actuator, the force limiter may be a valve that restricts the flow of hydraulic fluid when actuated. As used herein “restrict” means to limit, but not prevent, the flow. When the valve is in the normal operating position, fluid under pressure is transferred in a normal manner. The valve may be actuated upon application of a predetermined excessive hydraulic flow rate to redirect the hydraulic flow through a secondary fluid passage. For example, the normal operating position may be “open” and the valve may close position due to increased flow rate, such that the secondary fluid passage becomes the only flow path and prevents excessive flow from being transferred from the clutch side and the transmission. Alternatively, the valve may be a ball check valve with a notched valve seat. In this example, the notched valve seat forms the secondary fluid passage when the ball check valve is closed.

In another example, the actuator may be a mechanical actuator, such as a clutch cable. For a mechanical actuator, the force limiter may be a shock absorber, which acts under high velocity to absorb excess motive force.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic of a clutch system having a hydraulic control element.

FIG. 2 is a detailed schematic view of a hydraulic control element.

FIG. 3 is a detailed schematic view of an alternate hydraulic control element

FIG. 4 is a schematic of a clutch system being modified to include a control element.

FIG. 5 is a schematic of a clutch having cable control element.

### DETAILED DESCRIPTION

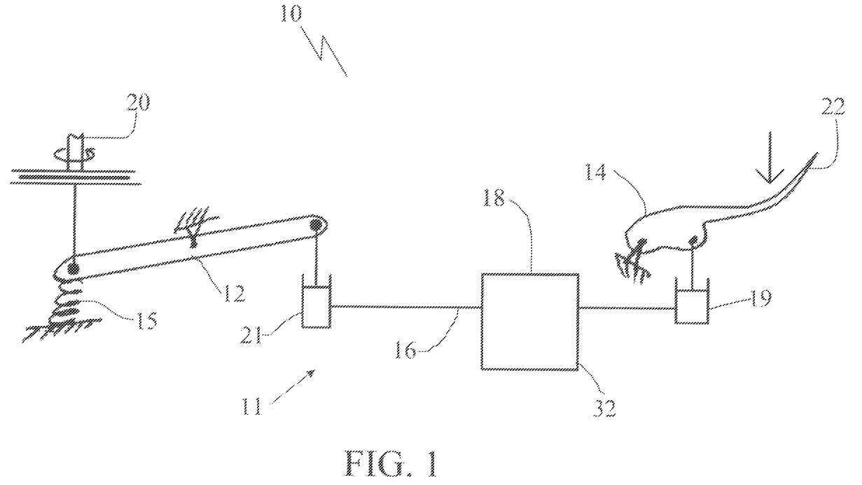

A manually operated clutch, generally identified by reference numeral 10, will now be described with reference to FIG. 1 through 5.

### Structure and Relationship of Parts:

Referring to FIG. 1, clutch 10 includes an actuator 11 with an engagement portion 12, and a control portion 14. Control portion 14 is connected to a clutch lever 22, and applies a force to disengage engagement portion 12 from a transmission 20. When released, control portion 14 allows a spring 15 (or other restoring force as will be recognized by those skilled in the art), to re-engage engagement portion 12 with transmission 20. Clutch lever 22 is controlled by an operator. The return of engagement portion 12 to an engaged position will generally be determined by the speed at which clutch lever 22 is released by the operator. When clutch lever 22 is released quickly, spring 15 causes clutch 10 to be engaged quickly, which can result in a high rate of clutch wear or early failure of driveline components. To reduce the impact of this, a force limiter 18 is positioned between engagement portion 12 and control portion 14. Force limiter 18 acts to limit spring 15 from applying a motive force that is beyond a predetermined threshold. The present design is concerned with controlling the motive force that causes clutch 10 to engage transmission 20. This force is generally applied by spring 15 as regulated by the operator's control over clutch lever 22. The force required to disengage transmission 20 generally does not cause damage, and is not considered herein.

The predetermined threshold for the motive force will be the point at which the force may result in damage or excess wear. This threshold may be calculated with a margin for safety or error, and will generally be calculated based on the motive forces applied during “normal” operation. This may be the range in which the clutch was designed to operate, and generally corresponds to the range in which most drivers operate clutch 10. Force limiter 18 preferably only operates above a certain threshold and acts to limit the force to that threshold, In other words, force limiter 18 preferably allows actuator 11 to operate as if force limiter 18 were not present up to a maximum motive force, but not above that maximum value. Other solutions could also be used, such as the force limiter having an effect that increases with an increased motive force. This would mean that actuator 11 would not operate as it would without force limiter 18, but the effect of force limiter 18 would increasingly limit the motive force at higher forces.

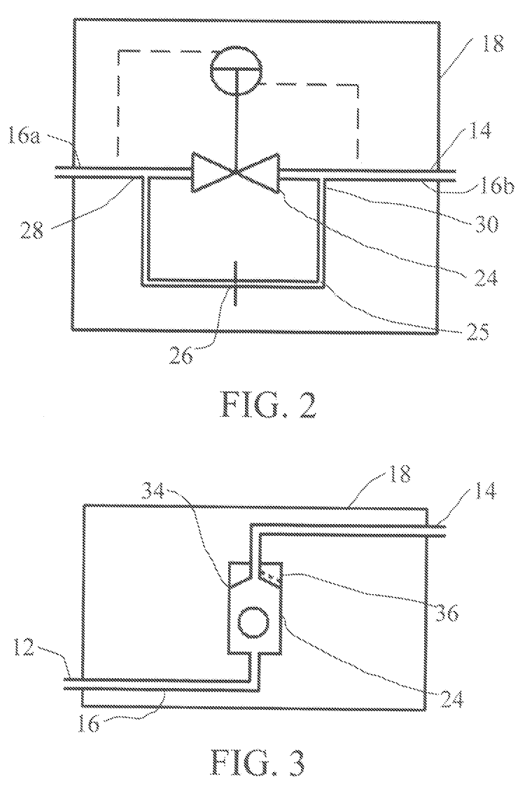

Referring to FIG. 1, actuator 11 may be a hydraulic actuator that uses a hydraulic hose 16 to transfer pressure between two actuators 19 and 21. Referring to FIG. 2, control element 18 may have a valve 24 that restricts hydraulic flow when actuated. In the depicted embodiment, hydraulic flow from hose section 16a creates a pressure drop through the valve 24 as it flows to hose section 16b. Upon a predetermined pressure drop being reached, valve 24 will close, and redirect fluid through a secondary flow passage 25, the flow rate of which is defined by an orifice 26. Secondary flow passage 25 flows in parallel with valve 24 and has a first end 28 connected to hydraulic hose section 16a upstream of valve 24 and a second end 30 connected to hydraulic hose section 16b downstream of valve 24. When valve 24 is in the closed position, secondary flow passage 25 becomes the only flow path from the side with engagement portion 12 to the side with control portion 14.

It will be understood that different types of control elements 18 may be used. For example, instead of closing, valve 24 may be a three-way valve that directs the hydraulic fluid through a restricted secondary flow passage 25. Referring to FIG. 3, in another example valve 24 may be a “leaky” check valve, such as a ball check valve 34 with a notched valve seat 36, which allows leakage through valve 24 when in the closed position. As shown, valve 24 is vertical and is kept open by gravity. Other designs may also be used, such as valves that use a restoring force that must be overcome to close the valve, such as by a spring.

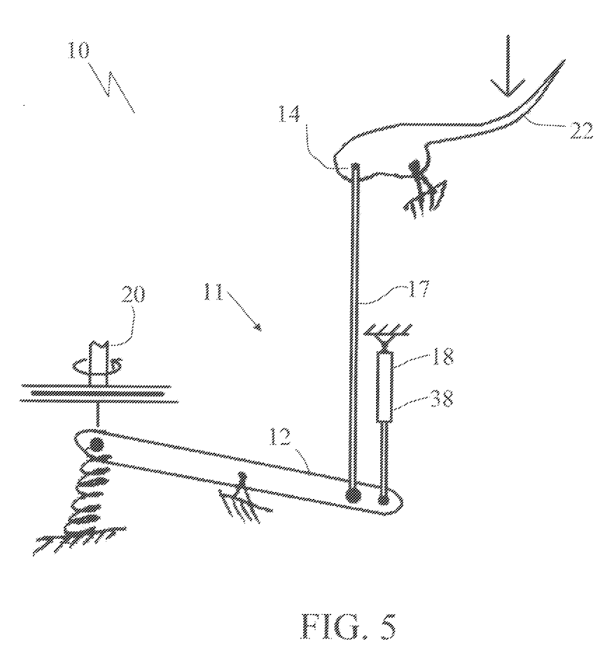

Referring to FIG. 5, actuator 11 may a mechanical actuator, which uses a clutch cable 17. In this example, force limiter 18 is a speed-limiting shock absorber 38. As force is applied to control portion 14, shock absorber 38 will become compressed. If the handle 22 is released at a high rate of speed the motive force exceeds the predetermined threshold. Shock absorber 38 acts to reduce the force transferred to engagement portion 12, and slowing the engagement with transmission 20.

### Operation:

There will now be discussed the operation and installation of the example depicted in FIG. 1. Referring to FIG. 1, control element 18 protects transmission 20 by limiting the motive force through control line 16 during aggressive use. In a hydraulic circuit, such as in the embodiment currently described, the motive force is related to the flow of hydraulic fluid within actuator 11. An operator engages clutch lever 22, which causes hydraulic pressure to be transferred from control portion 14 to engagement portion 12 through actuator 11 to disengage the clutch, Referring to FIG. 2, in normal re-engagement of the clutch, valve 24 remains in the open position and hydraulic fluid is allowed to flow freely through valve 24. During engagement, if the hydraulic flow through actuator 11 increases beyond a predetermined threshold, valve 24 moves to the closed position, With valve 24 in the closed position, secondary flow passage 25 becomes the only flow path for the hydraulic fluid, with the flow being restricted by orifice 26. This reduces the rate at which the motive force at engagement portion 12 is applied, and therefore reduces the strain between engagement portion 12 and transmission 20. Once the pressure drops below the threshold, valve 24 will again open and allow fluid to flow freely.

The operation of the other embodiments will be apparent to those skilled in the art, For example, instead of closing, valve 24 may move to a different position that redirects fluid through a restricted flow path. Alternatively, referring to FIG. 3, valve 24 may be a “leaky” valve that, when closed, still permits a certain amount of fluid to flow. For a mechanical actuator 11, a shock absorber 38 may be actuated to reduce the force applied to engagement portion 12, as described above.

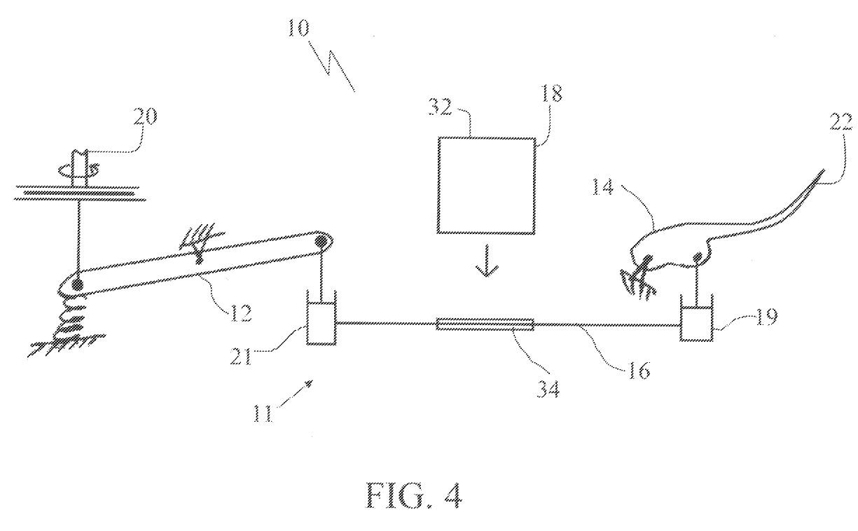

Referring to FIG. 4, an existing clutch 10 may be modified to operate as described herein, In the case of a hydraulic actuator 11, as discussed with respect to FIG. 1, force limiter 18 is installed by opening a section 34 of hydraulic line 16, and connecting force limiter such that valve 24 is into the hydraulic flow path 16. In the case of a mechanical actuator 11, as discussed with respect to FIG. 5, such as a clutch cable 17, shock absorber 38 is installed such that it can reduce the motive force applied to engagement portion 12. Shock absorber 38 may be installed in association with different moving components, depending on the type of shock absorber used, and the preferences of the user. Once installed, force limiter 18 appears “invisible” to most operators, and its effect is only noticed when the clutch is operated in an overly aggressive manner,

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A manually operated clutch, comprising:
an actuator having a control portion and an engagement portion, the control portion controlling a motive force that engages the engagement portion with a transmission; and
a force limiter between the control portion and the engagement portion that limits the motive force above a predetermined threshold.

2. The manually operated clutch of claim 1, wherein the actuator is a hydraulic actuator, and the motive force is hydraulic pressure.

3. The manually operated clutch of claim 2, wherein the force limiter comprises a valve, the valve being actuated upon application Of a predetermined hydraulic pressure to restrict the flow of hydraulic fluid.

4. The manually operated clutch of claim 3, wherein the valve is a ball check valve.

5. The manually operated clutch of claim 4, wherein the ball check valve has a notched valve seat that restricts the flow of hydraulic fluid when the ball check valve is actuated.

6. The manually operated clutch of claim 1, wherein the actuator is a clutch cable.

7. The manually operated clutch of claim 6, wherein the force limiter comprises a shock absorber.

8. The manually operated clutch of claim 1, wherein the motive force is a spring, and the control portion acts against the spring to disengage the engagement portion.

9. A method of modifying a manually operated clutch, the manually operated clutch comprising a control portion and an engagement portion, the control portion controlling a motive force that engages the engagement portion with a transmission, the method comprising the steps of:
inserting a force limiter between the control portion and the engagement portion that limits the motive force above a predetermined threshold.

10. The method of claim 9, wherein the actuator is a hydraulic actuator, and the motive force is hydraulic pressure.

11. The method of claim 10, wherein the force limiter comprises a valve, the valve being actuated upon application of a predetermined hydraulic pressure to restrict the flow of hydraulic fluid.

12. The method of claim 11, wherein the valve is a ball check valve.

13. The method of claim 12, wherein the ball check valve has a notched valve seat that restricts the flow of hydraulic fluid when the ball check valve is actuated.

14. The method of claim 9, wherein the actuator is a clutch cable.

15. The method of claim 14, wherein the force limiter comprises a shock absorber.

16. The method of claim 9, wherein the motive force is a spring, and the control portion acts against the spring to disengage the engagement portion.

17. In combination:
a transmission for a motor vehicle;
a manually operated clutch, comprising:
a control lever;
an actuator having a control portion connected to the control lever and an engagement portion connected to the transmission, the control portion controlling a motive force that engages the engagement portion with the transmission; and
a force limiter between the control portion and the engagement portion, the control portion limiting the motive force above a predetermined threshold.

18. The combination of claim 17, wherein the actuator is a hydraulic actuator, and the motive force is hydraulic pressure.

19. The combination of claim 18, wherein the force limiter comprises a valve, the valve being actuated upon application of a predetermined hydraulic pressure to restrict the flow of hydraulic fluid through the secondary fluid passage.

20. The combination of claim 19, wherein the valve is a ball check valve.

21. The combination of claim 20, wherein the ball check valve has a notched valve seat that restricts the flow of hydraulic fluid when the ball check valve is actuated,

22. The combination of claim 17, wherein the actuator is a clutch cable.

23. The combination of claim 22, wherein the force limiter comprises a length adjustable shock absorber.

24. The combination of claim 17, wherein the motive force is a spring, and the control portion acts against the spring to disengage the engagement portion.
